(19) United States
(12) Patent Application Publication
(10) Pub. No.: US 2007/0136807 A1
(43) Pub. Date: Jun. 14, 2007

(54) System and method for detecting unauthorized boots

(76) Inventors: Daniel C. DeLiberato, Natick, MA (US); Philip John Steuart Gladstone, Carlisle, MA (US); Alan J. Kirby, Hollis, NH (US)

Correspondence Address: FENWICK & WEST LLP, SILICON VALLEY CENTER, 801 CALIFORNIA STREET, MOUNTAIN VIEW, CA, 94041, US

(21) Appl. No.: 11/302,685

(22) Filed: Dec. 13, 2005

(51) Int. Cl. G06F 12/14

(52) U.S. Cl. 726/22; 726/1

(57) ABSTRACT

A system and method for detecting unauthorized boots and adjusting security policy. According to one embodiment of the present invention, the BIOS stores boot information in a data store from which it can later be distributed on a network and/or accessed by security software. The security software compares a signature of the operating system booted by the computer to a signature of a trusted, or authorized, operating system. The security software is capable of determining whether an attempted boot is authorized and can adjust security policy in response to the boot information.

### BACKGROUND OF THE INVENTION

1. Field of the Invention

The invention generally relates to computer security, and, specifically, to the detection and treatment of unauthorized computer boots.

2. Description of Background Art

Given the increased use of computers for mission-critical applications and the processing of confidential data, computer security is an issue of continually increasing importance. Many techniques exist for attempting to limit the capabilities of malicious users or processes. Several modem operating systems limit access to data and computer resources to specific users or groups of users, and several security applications are available to limit the ability of malicious code to operate without the permission of the user in the context of a trusted operating system.

However, a malicious user can sometimes sidestep such limitations by loading, i.e., booting, a different operating system. Loading a different operating system can give the malicious user access to the data and computing resources of the system without the access restrictions and security precautions of the trusted operating system. Sometimes a malicious user can boot a different operating system, and reconfigure or disable the trusted operating system in a way that makes it insecure. Subsequent users may then use the trusted operating system without knowing that the trusted operating system has been compromised.

Booting a different operating system on a computer is generally not very difficult. On most computer systems, physical access to the computer is sufficient to allow a user to redirect the pre-configured boot process to a different storage location and thereby boot a different operating system. The user may boot a different operating system from the local hard drive, or he may supply a foreign operating system using, for example, another hard drive, a CD-ROM, a memory stick, or a floppy disk.

Some computer systems are capable of recording that a boot has occurred. However, as booting is a normal component of computer system use, the mere fact that a boot has occurred is not cause for security concern. Given that the trusted operating system may be booted dozens of times a day, the deluge of authorized boot entries limits the usefulness of logging boots for security purposes. For the recording of boots to be useful, there would need to be a way to distinguish between authorized and unauthorized boots.

Furthermore, once an unauthorized boot is detected, it is desirable to take action so that the unauthorized boot does not compromise the security of other computers. In a computer system with predefined rules governing the security practices of the system, i.e., a security policy, it is desirable to adjust these rules in response to detecting an unauthorized boot.

Therefore, what is needed is a method for detecting unauthorized boots and adjusting security policy accordingly.

### BRIEF DESCRIPTION OF THE DRAWINGS

FIG. 1 is a block diagram illustrating computer systems connected to a network, according to one embodiment of the present invention.

FIG. 2 is a block diagram illustrating a client computer, according to one embodiment of the present invention.

FIG. 3 is an illustration of boot information data flow, according to one embodiment of the present invention.

FIG. 4 is a flow chart illustrating a method for detecting unauthorized boots, according to one embodiment of the present invention.

FIG. 5 is a flow chart illustrating a method for processing information regarding unauthorized boots, according to one embodiment of the present invention.

FIG. 6 is a flow chart illustrating a method for adjusting local security policy in response to an unauthorized boot, according to one embodiment of the present invention.

FIG. 7 is a flow chart illustrating a method for adjusting group security policy in response to an unauthorized boot, according to one embodiment of the present invention.

### DETAILED DESCRIPTION OF THE PREFERRED EMBODIMENTS

A preferred embodiment of the present invention is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

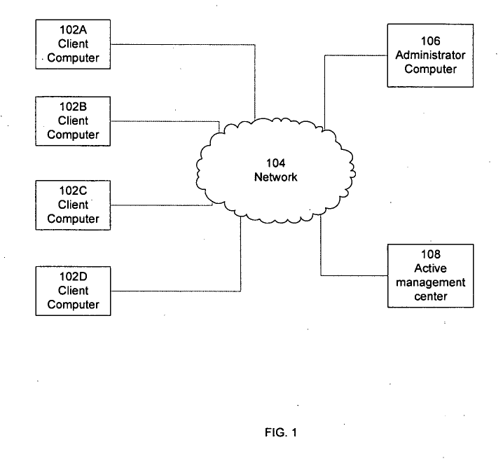

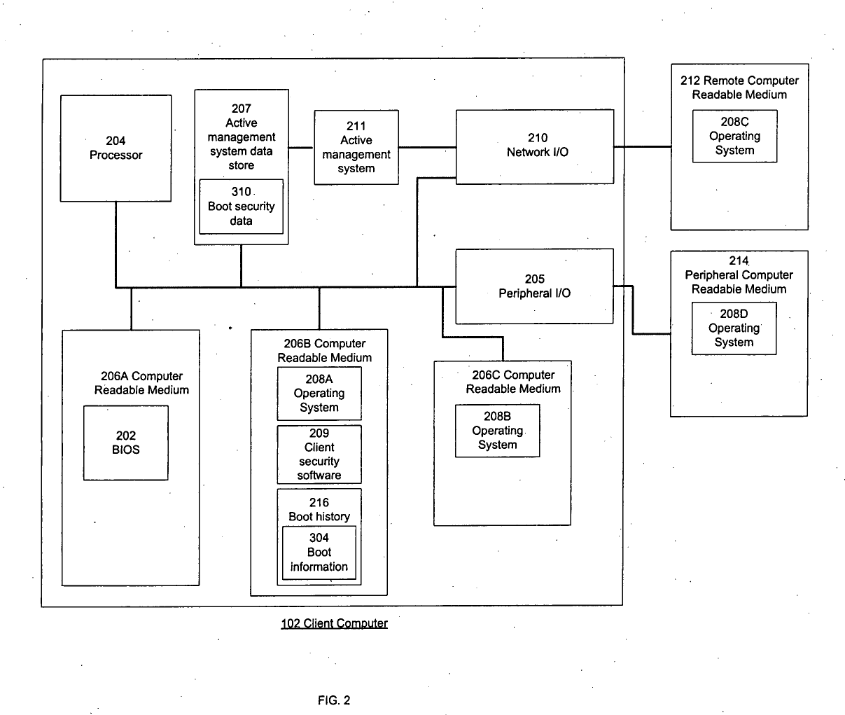

FIG. 1 is a block diagram illustrating computer systems connected to a network, according to one embodiment of the present invention. A plurality of client computers 102 are connected to the network 104. The client computer 102 may be any computer for which it is desired to detect unauthorized boots. The client computer 102, according to one embodiment of the present invention, is described in greater detail herein with reference to FIG. 2.

The network 104 may be implemented using any of the available methods for connecting computers to facilitate the bidirectional transfer of data. According to one embodiment of the present invention, the network 104 may be implemented as a local area network, or it may be implemented as a wide area network, such as the internet.

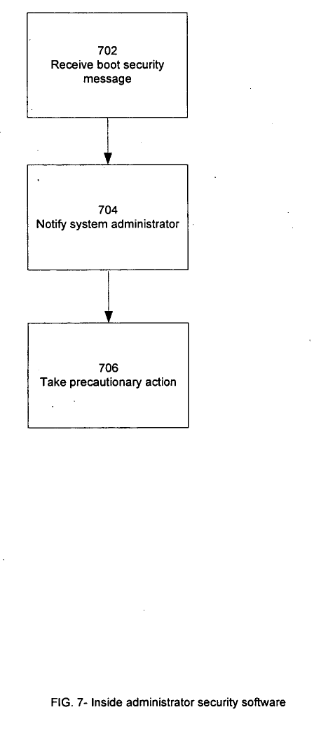

The administrator computer 106 is a computer system that is given the ability to monitor the unauthorized boots of the clients computer 102 and to establish a security policy in that will be used in response to unauthorized boots. The method used by the administrator computer 106, according to one embodiment of the present invention, will be described in greater detail herein with reference to FIG. 7. The administrator computer 106 is connected to the network 104.

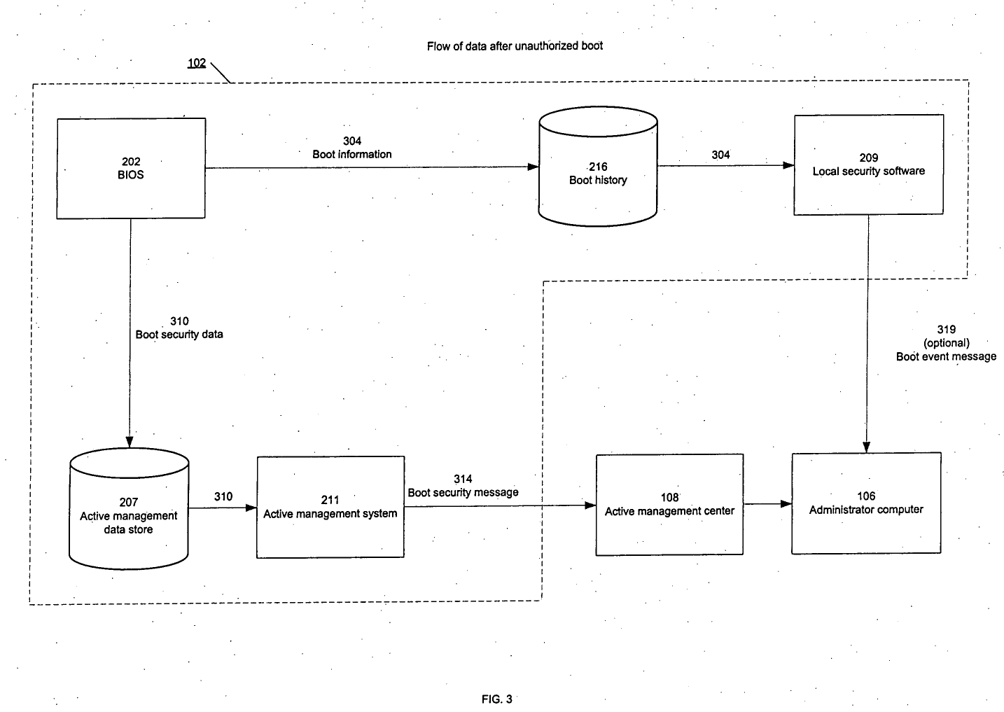

The active management center 108 is a device for configuring and monitoring the active management systems, which are described in greater detail herein with reference to FIG. 3. According to one embodiment of the present invention, the active management center 108 may be implemented using an Intel® Active Management Technology (AMT) Management Center. The active management center 108 is connected to the network 104.

FIG. 2 is a block diagram illustrating a client computer, according to one embodiment of the present invention. The processor 204 is capable of executing computer instructions.

Coupled to the processor 204 is a plurality of computer readable media 206. For the purposes of illustration the computer readable media 206 have been shown as discrete entities; one skilled in the art will recognize that multiple computer readable media 206 as shown could be physically embodied in a single computer readable medium. The computer readable medium 206 is capable of storing computer instructions to be executed by the processor 204.

The computer readable medium 206A includes a basic input/output system, or BIOS 202. The BIOS 202 is formed of computer instructions that may be executed by the processor 204. The BIOS 202 may be stored in a read-only memory (ROM), a flash random-access memory, or another form of computer-readable medium.

The BIOS 202 may have the capability to perform standard BIOS functions, such as testing and initializing devices and loading further computer instructions for execution by the processor 204 from a computer readable medium 206, a remote computer readable medium 212, or a peripheral computer readable medium 214.

The computer readable medium 206B includes an operating system 208A. The operating system 208 is formed of computer instructions for execution by the processor 204. The operating system 208 may be a typical functioning operating system (such as Microsoft® Windows or Linux), or it may be a second-stage boot loader, including computer instructions for loading the operating system proper (such as NTLDR or GRUB). For the purposes of illustration, the term operating system will be used herein to describe either a typical functioning operating system or a second-stage boot loader.

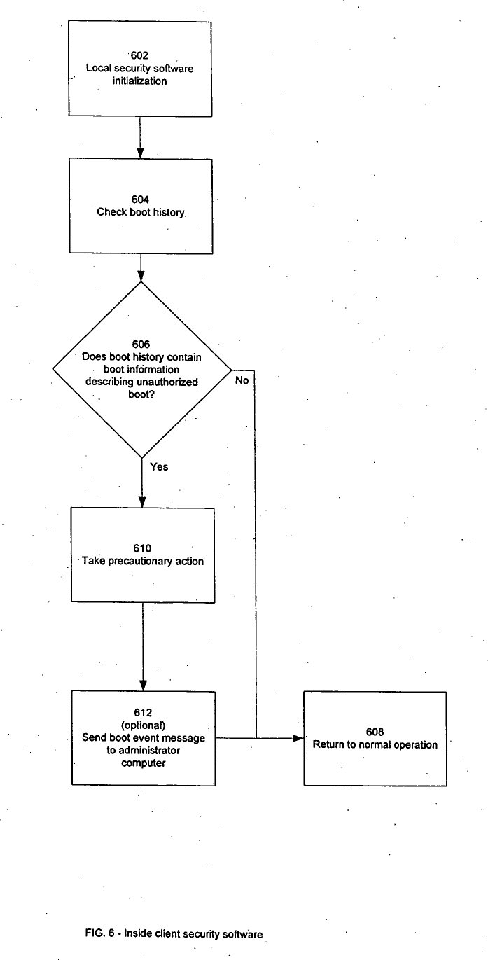

The computer readable medium 206B also includes client security software 209. For the purposes of illustration, the client security software 209 is depicted as being stored on the computer readable medium 206B. According to one embodiment of the present invention, the client security software 209 may instead be stored on a different computer readable medium, such as, for example, the remote computer readable medium 212. The method used by the client security software 209, according to one embodiment of the present invention, will be described in greater detail herein with reference to FIG. 6.

One of the computer readable media 206 contains the boot history 216. The boot history 216 is a data store capable of storing data written by the BIOS 202. The boot history 216, or an electronic copy of it, is accessible by the operating system 208. For example, the boot history may be stored using a System Management Basic Input/Output System (SMBIOS) boot history.

According to one embodiment of the present invention, the boot history 216 can be stored in a way such that is cannot be easily modified by unauthorized computer instructions, for example, using a secure data store. According to one embodiment of the present invention, the boot history 216 is implemented using a trusted platform module (TPM). For the purposes of illustration, the boot history 216 is depicted as residing in the same computer readable medium 206 as the client security software 209 and the operating system 208A; one skilled in the art will recognize the boot history 216 may reside independently of these other components and may be stored in any computer readable medium 206. The boot history is beneficial as it provides a data store through which information about boots may be passed from the BIOS to the client security software.

According to one embodiment of the present invention, the computer readable medium 206C includes an operating system 208B.

The network I/O 210 is coupled to the processor 204 and the computer readable medium 206. The network I/O 210 is capable of sending and receiving messages on the network 104. According to one embodiment of the present invention, the network I/O 210 may be connected to a remote computer readable medium 212. According to one embodiment of the present invention, the remote computer readable medium 212 contains an operating system 208C. According to one embodiment of the present invention, the remote computer readable medium 212 may be the hard drive of a server containing an operating system that may be booted remotely.

The peripheral I/O 205 is coupled to the processor 204 and the computer readable medium 206. The peripheral I/O 205 is capable of storing and retrieving data from a peripheral computer readable medium 214. The peripheral computer readable medium 214 could be any of the commonly available peripheral computer readable media, such as, for example, a floppy disk, CD-ROM, or memory stick. According to one embodiment of the present invention, the peripheral computer readable medium 214 may contain an operating system 208D.

Thus, according to one embodiment of the present invention, the processor 204 is coupled to various computer readable media 206 containing various operating systems 208. The various operating systems 208 may or may not be different from each other in ways that are significant for security purposes. For example, the computer instructions forming the operating system 208B may be substantially similar to the computer instructions forming the operating system 208A, or they may contain discrepancies that could be used to compromise the security of the client computer 102.

The BIOS 202 is capable of loading further computer instructions to be executed by the processor 204. The BIOS 202 follows a series of rules to determine from which computer readable medium 206 (or remote computer readable medium 212 or peripheral computer readable medium 214) to load further computer instructions to be executed by the processor 204. According to one embodiment of the present invention, the BIOS 202 determines from which computer readable medium 206 (or remote computer readable medium 212 or peripheral computer readable medium 214) to load further computer instructions to be executed by the processor on the basis of user input.

The BIOS 202 is capable of loading the computer instructions of the operating system 208 residing on the selected computer readable medium 206 (or remote computer readable medium 212 or peripheral computer readable medium 214) for execution by the processor 204.

According to one embodiment of the present invention, also coupled to the processor 204 and the computer readable medium 206 is the active management system data store 207. The active management data store 207 is electronic storage that is readable by the active management system 211. According to one embodiment of the present invention, the active management data store 207 is also readable by the active management center 108.

The BIOS 202 is capable of storing data in the active management system data store 207. According to one embodiment of the present invention, the BIOS 202 stores data in the active management system data store 207 in the form of boot security data 310. Boot security data 310 is stored in the active management system data store 207 independently of the state of the operating system or system management hardware. For example, boot security data 310 may be stored in the active management system data store 207 as Platform Event Trap (PET) data. By storing boot security data 310, the BIOS is able to store boot information independently of the state of the operating system, allowing for the recording of unauthorized boots in situations when a malicious operating system might otherwise interfere with the recording of boots.

According to one embodiment of the present invention, also coupled to the active management system data store 207 and the network I/O 210 is the active management system 211.

The active management system 211 is a device capable of operating independently of the computer instructions executed by the processor 204. Since the invention is concerned with detecting unauthorized boots, it is beneficial to perform processing in a device whose functionality is not dependent on the booting of an authorized operating system. By processing boot security data 310 in a device capable of operating independently of the operating system, the system is able to detect and respond to unauthorized boots in situations when a malicious operating system might otherwise interfere with boot security procedures.

The active management system 211 is capable of reading boot security data 310 from the active management system data store 207. According to one embodiment of the present invention, the active management system 211 is capable of sending messages to the network 104 through the network I/O 210. According to one embodiment of the present invention, the active management system 211 sends messages to the network 104 in the form of boot security messages.

According to one embodiment of the present invention, the active management system 211 may be implemented using an Intel® Active Manage Technology (Intel® AMT) device, and the active management data store 207 may be implemented using an Intel® Active Management Technology Third Party Data Store (Intel® AMT3PDS).

FIG. 3 is an illustration of boot information data flow, according to one embodiment of the present invention.

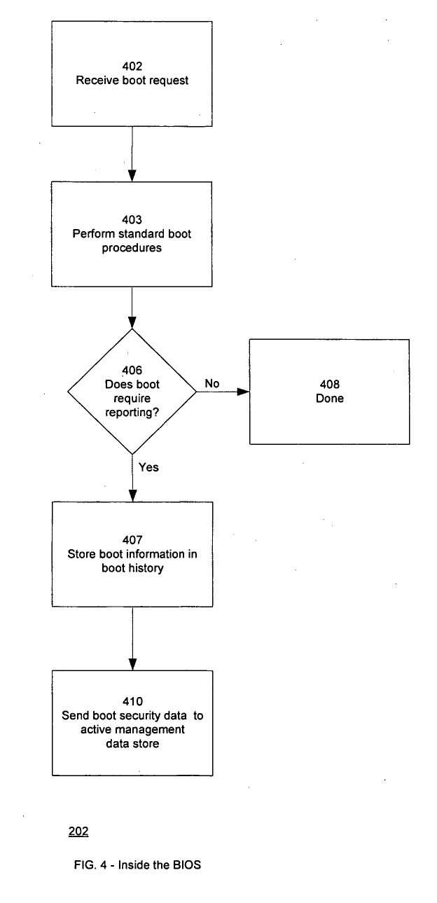

Beginning in the upper-left comer, the BIOS 202 determines information regarding the operating system 208 loaded, for example, from the computer readable medium 206 and generates boot information 304. The method used by the BIOS 202, according to one embodiment of the present invention, is described in greater detail herein with reference FIG. 4

The boot information 304 contains information pertaining to the computer instructions of whichever operating system 208 was loaded from the computer readable medium 206 (or remote computer readable medium 212 or peripheral computer readable medium 214). According to one embodiment of the present invention, the boot information 304 may contain information regarding the type of computer readable medium from which the computer instructions were loaded. For example, the boot information 304 may indicate that the computer instructions were loaded from a hard drive, a CD-ROM, a memory stick, a floppy disk, or a network location. According to another embodiment of the present invention, the boot information 304 may contain information describing the contents of the computer instructions that were loaded from the computer readable medium. For example, the boot information 304 may contain the output of a hash function on the first 512 bytes of the computer instructions loaded from the computer readable medium. According to yet another embodiment of the present invention, the boot information 304 may contain an indication that the computer instructions loaded from the computer readable medium were unauthorized instructions. The boot information 304 may also contain data relating to the time and circumstances of the loading of the computer instructions from the computer readable medium. Additionally, the boot information 304 may also contain data relating to previous boots.

According to one embodiment of the present invention, the bios 202 operates in conjunction with a trusted platform module (TPM) to receive information describing the contents of the computer instructions that were loaded from the computer readable medium.

The BIOS 202 stores the boot information 304 in the boot history 216.

The client security software 209 has the ability to read the boot history 216. According to one embodiment of the present invention, the client security software 209 has access to the boot history 216 through the operating system 208. The method of the client security software 209, according to one embodiment of the present invention, will be described in greater detail herein with reference to FIG. 6.

The boot security data 310 is capable of being stored in the active management data store 207. The boot security data 310 contains information pertaining to the computer instructions of the operating system 208 loaded from the computer readable medium 206 (or remote computer readable medium 212 or peripheral computer readable medium 214). According to one embodiment of the present invention, the boot security data 310 may contain information regarding the type of computer readable medium from which the computer instructions were loaded. For example, the boot security data 310 may indicate that the computer instructions were loaded from a hard drive, a CD-ROM, a memory stick, a floppy disk, or a network location. According to another embodiment of the present invention, the boot security data 310 may contain information describing the contents of the computer instructions loaded from the computer readable medium. For example, the boot security data 310 may contain the output of a hash function on the first 512 bytes of the computer instructions loaded from the computer readable medium. According to yet another embodiment of the present invention, boot security data 310 may contain an indication that the computer instructions loaded from the computer readable medium were unauthorized instructions. The boot security data 310 may also contain data relating to the time and circumstances of the loading of the computer instructions from the computer readable medium. Additionally, the boot information 304 may also contain data relating to previous boots.

The BIOS 202 stores the boot security data 310 in the active management data store 207.

The active management system 211 reads data from the active management data store 207, and, responsive to boot security data 310 indicating that an unauthorized boot has occurred, sends a boot security message 314.

The boot security message 314 is a message capable of being transmitted on the network 104. For example, the boot security message 314 may be implemented using a Platform Event Trap (PET) event, such as a ‘booted from’ PET event. The boot security message 314, according to one embodiment of the present invention, contains an indication that an unauthorized boot has occurred.

According to one embodiment of the present invention, the active management system 211 sends the boot security message 314 to an active management center 108. The active management center 108 is capable of receiving boot security messages from a plurality of sources, for example the plurality of client computers 102, and forwarding boot security messages on to a recipient on the basis of a predetermined routing table. The active management center 108 forwards the boot security message 314 received from the active management system 211 to the administrator computer 106.

According to another embodiment of the present invention, the active management system 211 sends the boot security message 314 to the administrator computer 106 directly.

The administrator computer 106 is capable of receiving boot security messages 314. According to another embodiment of the present invention, the administrator computer 106 is capable of receiving a boot event message 319. The method used by the administrator computer 106, according to one embodiment of the present invention, will be described in greater detail herein with reference to FIG. 7.

The boot event message 319 is a message containing an indication that an unauthorized boot has occurred. According to one embodiment of the present invention, the client security software 209 generates a boot event message 319 and sends it to the administrator computer 106.

In one embodiment, the BIOS 202 writes boot information 304 in the boot history 216. Having the BIOS 202 write the boot information 304 in the boot history 216 is beneficial because it allows the client security software 209 to detect unauthorized boots and adjust security policy accordingly. In another embodiment, the BIOS 202 writes boot security data 310 in the active management data store 207. Having the BIOS 202 write the boot security data 310 in the active management data store 207 is beneficial because it allows the administrator computer 106 to notify the administrator that an unauthorized boot has occurred and adjust security policy accordingly. Additionally, by writing the boot security data 310 in the active management data store 207, appropriate action can be taken quickly after the unauthorized boot occurs, and without the need for client security software running on the computer that is being booted.

It will be apparent to one skilled in the arts that both the flow of data (such as boot information 304) through the boot history 216 and the flow of data (such as the boot security data 310) through the active management data store 207 are independently beneficial for the purposes of detecting unauthorized boots and adjusting security policy, and that either one or both may be implemented to achieve the benefits of the present invention.

FIG. 4 is a flow chart illustrating a method for detecting unauthorized boots, according to one embodiment of the present invention. According to one embodiment of the present invention, the method is performed by the BIOS 202. In other embodiments, other entities in the system may perform this method.

The BIOS 202 receives 402 a boot request. The BIOS may receive 402 a boot request by a signal from hardware, from the operating system, or from another source.

The BIOS 202 performs 403 standard boot procedures. For example, the BIOS 202 may test or initialize devices, determine a computer readable medium from which to boot an operating system, and load the computer instructions of the operating system from the determined computer readable medium. According to one embodiment of the present invention, an identifier of the computer readable medium determined by the BIOS 202 is stored in either the active management data store 207 or the boot history 216. This identifier may be, for example, the volume title of the computer readable medium.

The BIOS 202 determines 406 if the boot requires reporting. The BIOS 202 may determine 406 if the boot requires reporting using a variety of techniques.

According to one embodiment of the present invention, the BIOS 202 determines 406 if the boot requires reporting by comparing a signature of the loaded computer instructions to a signature of the authorized computer instructions, or of computer instructions that do not require reporting. A signature may be any data that is dependent in some way on a set of computer instructions. For example, a signature generator may have as input the contents of the computer instructions, the computer readable medium from which the computer instructions were loaded, or the manner in which the computer instructions were loaded from the computer readable medium. This list is not intended to be exhaustive, and any number of signature generators could be implemented in the interest of comparing various characteristics of computer instructions.

According to one embodiment of the present invention, the determination 406 is responsive to an identifier of the computer readable medium from which the operating system was loaded. For example, if the computer readable medium from which the operating system was loaded is identified as a CD-ROM, and the computer readable medium from which the authorized operating system was expected to be loaded is identified as a hard disk, the BIOS 202 may determine 406 that the boot requires reporting. As a further example, if the computer readable medium from which the operating system was loaded is identified as a hard disk with volume label F, and the computer readable medium from which the authorized operating system was expected to be loaded is identified as a hard disk with volume label C, the BIOS 202 may determine 406 that the boot requires reporting.

According to another embodiment of the present invention, the determination 406 is responsive to an identifier related to the content of the operating system that was loaded. For example, if the operating system that was loaded is identified as Linux, and the operating system that was authorized to be loaded was Microsoft® Windows, the BIOS 202 may determine 406 that the boot requires reporting. As another example, if the operating system that was loaded is identified as a first version of Linux, and the operating system that was operated to be loaded was a second version of Linux, the first version at least substantially different from the first, the BIOS 202 may determine that the boot requires reporting. The determination 406 may be made on the basis of any characteristic having to do with the origin, result, or circumstances of the loading by the BIOS 202 of computer instructions from a computer readable medium.

According to one embodiment of the present invention, the determination 406 is responsive to a comparison of (a) information relating to the boot and (b) predetermined information expected during an authorized boot. According to another embodiment of the present invention, the determination 406 is responsive to a comparison of (a) information relating to the boot and (b) predetermined information expected during an unauthorized boot.

According to one embodiment of the present invention, the step of determining 406 if the boot requires reporting is dependent on determining if the boot was authorized. According to another embodiment of the present invention, the step of determines 406 if the boot requires reporting is dependent on determining if the boot is likely to be an unauthorized boot.

Determining 406 if the boot requires reporting is beneficial, as it can reduce the processing overhead and storage required to detect boots that pose a potential security concern, while also ensuring that those boots that are likely to be determined to be unauthorized are recording appropriately. Depending on the application, the threshold for when a boot should be reported may be adjusted appropriately. According to one embodiment of the present invention, every boot is determined to require reporting. According to another embodiment of the present invention, only boots that are unauthorized are determined to require reporting.

If the BIOS 202 determines 406 that the does not require reporting, no further action is required and the BIOS 202 is done 408.

If the BIOS 202 determines 406 that the boot does require reporting, the BIOS 202 stores 407 boot information in the boot history. The boot information may include, for example, such data as an identifier of the computer readable memory from which the operating system was loaded, a hash of the computer instructions comprising the operating system that was loaded, and the time and circumstances of the received boot request.

Optionally, the BIOS 202 also sends 410 boot security data 310 to the active management data store. According to one embodiment of the present invention, the boot security data includes indication that an unauthorized boot has occurred. The boot security data may also contain data relating to the time and circumstances of the loading of the operating system.

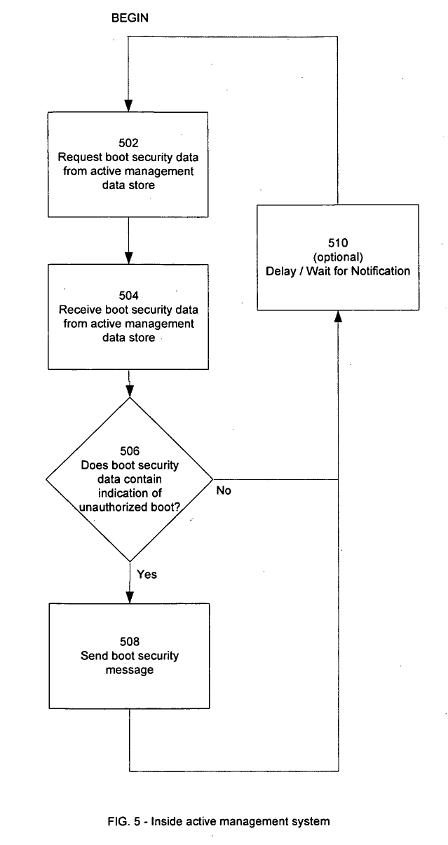

According to one embodiment of the present invention, the BIOS 202 also sends a boot security message 314. Boot security messages are described in greater detail herein with reference to FIG. 5.

According to another embodiment of the present invention, the BIOS 202 stores 407 the boot information in the boot history 216 regardless of the determination 406.

FIG. 5 is a flow chart illustrating a method for processing information regarding unauthorized boots, according to one embodiment of the present invention. According to one embodiment of the present invention, the method is performed by the active management system 211.

The active management system 211 requests 502 boot security data from the active management data store 207.

The active management system 211 receives 504 boot security data from the active management data store 207.

The active management system 211 determines 506 if the boot security data received 504 from the active management data store 207 contains indication of an unauthorized boot. For example, the active management system 211 may compare the data in the boot security data to data indicative that a boot was unauthorized. If the active management system 211 determines 506 that the boot security data received 504 from the active management data store 207 does not contain indication of an unauthorized boot, the active management system 211 returns to the beginning and again requests 502 boot security data from the active management data store 207. According to one embodiment of the present invention, the active management system 211 delays 510 for a period of time before again requesting 502 boot security data from the active management data store. According to another embodiment of the present invention, the active management system 211 waits 510 for notification before requesting 502 boot security data from the active management data store.

If the active management system 211 determines 506 that the boot security data received 504 from the active management data store 207 does contain indication of an unauthorized boot, the active management system 211 sends 508 a boot security message. According to one embodiment of the present invention, the active management system 211 sends 508 multiple boot security messages, either to multiple destinations or to the same destination, to improve the likelihood of successful transmission. According to one embodiment of the present invention, the active management system 211 may also store an indication that a boot security message has already been sent in response to the boot security data. According to one embodiment of the present invention, the determination 506 may additionally include determining if a boot security message has already been sent in response to the boot security data.

FIG. 6 is a flow chart illustrating a method for adjusting local security policy in response to an unauthorized boot, according to one embodiment of the present invention. According to one embodiment of the present invention, the method is performed by the client security software 209.

The client security software 209 initializes 602. The initialization 602 of the client security software 209 may occur as part of the routine start-up of the operating system, or it may occur responsive to user input. The initialization 602 of the client security software 209 may include security steps such as establishing the client security software in memory, checking if other applications are currently active, and enacting a security policy.

The client security software 209 checks 604 the boot history 216. The client security software 209 may copy the boot history 216, or it may refer to the boot history 216 in its current place in a computer readable memory 206, or the client security software 209 may access the boot history 216 through the operating system. In one embodiment of the present invention, the client security software 209 receives the boot history 216 over a network.

The client security software 209 determines 606 if the boot history contains boot information describing an unauthorized boot. For example, determining if the boot history contains boot information describing an unauthorized boot may include comparing the identifier of the computer readable media from which the computer system was booted to a list of identifiers of computer readable media from which boots are authorized. As another example, determining if the boot history contains boot information describing an unauthorized boot may include comparing the computer instructions loaded during the boot process to computer instructions that are known to be authorized.

As yet another example, determining if the boot history contains boot information describing an unauthorized boot may include comparing a list of entries in the boot history to a list of entries in a log of client security software initializations to determine if a boot has occurred without subsequent initialization of client security software.

If the client security software 209 determines 606 that the boot history does not contain boot information describing an unauthorized boot, the client security software 209 returns 608 to normal operation.

If the client security software 209 determines 606 that the boot history contains boot information describing an unauthorized boot, the client security software 209 takes 610 precautionary action. For example, the client security software 209 may either enforce a new security policy or adjust the security policy currently in place for the client system. A security policy may be, for example, a set of rules preventing certain operations from being performed by the operating system or user. Taking 610 precautionary action may also include, for example, forcing the execution of scanning or cleaning software.

Taking 610 precautionary action may include limiting functionality. According to one embodiment of the present invention, the client security software 209 limits the functionality of the client system 102 when the client security software 209 determines 606 that the boot history contains boot information describing an unauthorized boot. The client security software 209 may limit network access by the client system. For example, the client security software 209 may restrict the network activities of the client system, or the client security software 209 may prevent the client system 102 from transmitting or receiving data on the network 104 entirely. Limiting the functionality of the client system 102 may also include, for example, preventing a user from having access to the computer, limiting the software the computer is allowed to execute to certain trusted software, or physically restricting access to the computer.

According to one embodiment of the present invention, the client security software 209 may also store security state data indicating that an unauthorized boot has occurred and indicating that precautionary action should be taken in the future. The security state data may be reset by an administrator or authorized user. According to one embodiment of the present invention, the security state data may be stored in a manner such that it cannot be easily modified by unauthorized code.

According to one embodiment of the present invention, the client security software 209 sends 612 a boot event message to the administrator computer 106.

The client security software 209 returns 608 to normal operation.

According to one embodiment of the present invention, if the client security software 209 determines 606 that the boot history does contain boot information describing an unauthorized boot, the client security software 209 additionally determines if the boot information describing an unauthorized boot has been previously received by the client security software 209. If the client security software 209 determines that the boot information describing an unauthorized boot has been previously received by the client security software 209, the client security software 209 returns 608 to normal operation. If the client security software 209 determines that the boot information describing an unauthorized boot has been previously received by the client security software 209, the client security software 209 proceeds as described previously, beginning with taking 610 precautionary action. By determining if boot history containing boot information describing an unauthorized boot has been previously received by the client security software 209, the client security software 209 avoids multiple responses to the same unauthorized boot.

According to another embodiment of the present invention, if the client security software 209 determines 606 that the boot history does contain boot information describing an unauthorized boot, the client security software 209 additionally determines if the boot information describing an unauthorized boot indicates that the boot has been cleared by an administrator or other authorized user. By allowing an authorized user to clear an unauthorized boot, the client security software 209 facilitates efficient handling of and response to unauthorized boots.

FIG. 7 is a flow chart illustrating a method for notifying an administrator and adjusting group security policy in response to an unauthorized boot, according to one embodiment of the present invention. According to one embodiment of the present invention, the method is performed by the administrator computer 106.

The administrator computer 106 receives 702 a boot security message. According to one embodiment of the present invention, the administrator computer 106 may also receive 702 a boot event message. The administrator computer 106 notifies 704 a system administrator that an unauthorized boot has taken place. The notification may also include information such as which client computer performed the unauthorized boot, the time of the unauthorized boot, identifier data of the computer readable medium from which the unauthorized boot occurred, a history of recent unauthorized boot events, and the location of the client computer at the time of the unauthorized boot.

The administrator computer 106 takes 706 precautionary action. For example, the administrator computer 106 could modify a group-wide security policy, or take steps to exclude the computer that performed the unauthorized boot from the network.

While the invention has been particularly shown and described with reference to a preferred embodiment and several alternate embodiments, it will be understood by persons skilled in the relevant art that various changes in form and details can be made therein without departing from the spirit and scope of the invention.

1. In a computer system, a method for detecting if an attempted boot is unauthorized, comprising:
receiving information from a boot procedure about the attempted boot;
determining if the information indicates that the attempted boot is unauthorized; and
responsive to determining that the information indicates that the attempted boot is unauthorized, taking a predetermined action.

2. The method of claim 1, wherein the attempted boot includes selection of a computer readable medium having an identifier, and wherein determining if the information indicates that the attempted boot is unauthorized includes comparing the identifier of the computer readable medium to an authorized identifier.

3. The method of claim 1, wherein the attempted boot includes reading a volume title of a computer readable medium, and wherein determining if the information indicates that the attempted boot is unauthorized includes comparing the volume title of the computer readable medium to an authorized volume title.

4. The method of claim 1, wherein the attempted boot includes loading computer instructions, and wherein determining if the information indicates that the attempted boot is unauthorized includes comparing the computer instructions to authorized computer instructions.

5. The method of claim 1, wherein determining if the information indicates that the attempted boot is unauthorized includes comparing the information to information indicative of an authorized boot.

6. The method of claim 1, wherein determining if the information indicates that the attempted boot is unauthorized includes comparing the information to information indicative of an unauthorized boot.

7. The method of claim 1, wherein taking a predetermined action includes writing data into a data store indicating that an unauthorized boot has occurred.

8. The method of claim 7, wherein the data written into the data store comprises boot security data.

9. The method of claim 7, wherein the data written into the data store comprises boot information data.

10. The method of claim 1, wherein taking a predetermined action includes storing the information in a data store.

11. The method of claim 10, wherein the data store is an active management data store.

12. The method of claim 1, wherein taking a predetermined action includes sending a message indicating that an unauthorized boot has occurred.

13. The method of claim 12, wherein the message indicating that an unauthorized boot has occurred comprises a boot security message.

14. In a computer system, a method for determining if computer instructions loaded by a boot procedure are authorized computer instructions, comprising:
generating a signature of the computer instructions loaded by the boot procedure;
obtaining a signature of the authorized computer instructions; and
comparing the signature of the computer instructions loaded by the boot procedure and the signature of the authorized computer instructions to determine if the computer instructions loaded by the boot procedure are the authorized computer instructions.

15. The method of claim 14, wherein the computer instructions loaded by the boot procedure are loaded from a computer readable medium having a unique identifier, and the signature of the computer instructions loaded by the boot procedure is dependent on said identifier of said computer readable medium.

16. The method of claim 14, wherein the computer instructions loaded by the boot procedure is loaded from a computer readable medium having a unique identifier, and further comprising:
storing a record indicating said identifier of said computer readable medium.

17. The method of claim 14, further comprising:
responsive to the comparison of the signature of the computer instructions loaded by the boot procedure and the signature of the authorized computer instructions, writing a message into a data store indicating a boot event.

18. In a computer system, a system for determining if computer instructions loaded by a boot procedure are authorized computer instructions, comprising:
a computer readable medium having computer instructions thereon;
a boot loader for receiving said computer instructions from said computer readable medium as part of the boot procedure;
a signature generator dependent on said computer instructions and producing a first signature;
a signature generator dependent on the authorized computer instructions and producing a second signature; and
a comparator to determine from input of the first signature and the second signature whether said computer instructions are the authorized computer instructions.

19. The system of claim 18, wherein the computer readable medium has a unique identifier, and the first signature is dependent on said identifier.

20. The system of claim 18, wherein the first signature is dependent on the contents of the computer instructions received by the boot loader.

21. The system of claim 18, wherein said computer readable medium has a unique identifier, and further comprising:
storing a record indicating said identifier of said computer readable medium.

22. The system of claim 18, further comprising:
responsive to the comparison of the said first signature and said second signature, writing a message into a data store indicating a boot event.

23. The method of claim 1, wherein the method is performed by an active management system.

24. The method of claim 14, wherein the signature of the computer instructions loaded by the boot procedure is dependent on the contents of the computer instructions loaded by the boot procedure.

25. A method for securing a computer system comprising:
reading boot history data from a data store, wherein said boot history data comprises a record of booting a first set of computer instructions;
determining whether said boot history data indicates said first set of computer instructions were unauthorized computer instructions;
responsive to the determination that said boot history data indicates that said first set of computer instructions were unauthorized computer instructions, limiting a functionality of the computer system.

26. The method of claim 25, wherein said boot history data comprises a first source identifier, said first source identifier being associated with a computer readable medium from which said first set of computer instructions were booted.

27. The method of claim 26, wherein said determining whether said boot history data indicates said first set of computer instructions were unauthorized computer instructions comprises comparing said first source identifier to a second source identifier, the second source identifier being associated with a computer readable medium from which authorized computer instructions were expected to be booted.

28. The method of claim 25, wherein said determining whether said boot history data indicates said first set of computer instructions were unauthorized computer instructions comprises comparing the boot history data to security software history data.

29. The method of claim 25, further comprising:
responsive to the determination that the boot history data indicates that the first set of computer instructions were unauthorized computer instructions, notifying a user that an unauthorized boot has been detected.

30. The method of claim 25, wherein the boot history data is read from a secure data store.

31. The method of claim 25, wherein the functionality of the computer system is limited by enforcing a security policy.

32. The method of claim 25, wherein the functionality of the computer system is limited by restricting access of the computer system to a network.

33. The method of claim 25, wherein the functionality of the computer system includes executing an application, and wherein the functionality of the computer system is limited by preventing the computer system from executing the application.

34. The method of claim 25, wherein the functionality of the computer system includes providing access to a user, and wherein the functionality of the computer system is limited by preventing the computer system from providing access to the user.

35. A computer program product, the computer program product comprising a computer-readable medium, the computer-readable medium comprising:
program code for reading boot history data from a data store, wherein said boot history data comprises a record of booting a first set of computer instructions;
program code for determining whether said boot history data indicates said first set of computer instructions were unauthorized computer instructions;
program code, responsive to the determination that said boot history data indicates that said first set of computer instructions were unauthorized computer instructions, for limiting a functionality of the computer system.
